(19) United States
(12) Patent Application Publication
(10) Pub. No.: US 2018/0279620 A1
(43) Pub. Date: Oct. 4, 2018

(54) VETERINARY COMPOSITIONS FOR SANDFLY CONTROL

(71) Applicant: CEVA SANTE ANIMALE, Libourne (FR)

(72) Inventor: Marie VARLOUD, Libourne (FR)

(21) Appl. No.: 15/765,541

(22) PCT Filed: Oct. 7, 2016
(86) PCT No.: PCT/FR2016/052587

§ 371 Date: Apr. 3, 2018

(30) Foreign Application Priority Data
Oct. 9, 2015 (FR) 1559603

(51) Int. Cl. A01N 51/00; A01N 43/40; A01N 53/00; A01N 37/36

(52) U.S. Cl. CPC A01N 51/00; A01N 37/36; A01N 53/00; A01N 43/40

(57) ABSTRACT

The present invention relates to the use of a veterinary composition comprising a compound of the neonicotinoid family and a compound of the pyrethrinoid family for sandfly control and/or for leishmaniosis control in non-human mammals.

### TECHNICAL FIELD OF THE INVENTION

The present invention relates to the use of compositions in the veterinary field and more particularly in the parasitology field. The invention relates more specifically to the use of veterinary compositions for sandfly control and/or for leishmaniosis control in non-human mammals, such as cats and dogs.

### TECHNICAL BACKGROUND OF THE INVENTION

Sandflies are small insects of the order Diptera, of the suborder Nematocera and of the family Psychodidae. They are widespread in the Mediterranean region and in particular over a large part of Africa and the Middle East, and also in several countries of South America, such as Brazil.

Sandflies are the vector of leishmaniosis in human beings and mammals, such as dogs and cats, and are also vectors of numerous viruses in human beings. However, their direct pathogenic role which can cause immediate or delayed skin reactions is more limited.

More particularly, Phlebotomus perniciosus is known to be the main vector of Leishmania infantum in human beings and dogs. Thus, various treatments for controlling such a parasite and/or treating and preventing leishmaniosis have been developed and used.

For example, Danta-Torres (Vet. Parasitol., 2006, 141, 1-8) and Moreno et al. (PLoS One 6:e1683, 2012) have developed efficient vaccines against L. infantum. In particular, Moreno et al. have shown that the LiESP/QA-21 vaccine is capable of inducing a Th1 cellular response profile within three weeks after primary vaccination.

EP 1 022 944 describes the use of a collar comprising a compound of the pyrethroid family, in particular deltamethrin, for protecting dogs against sandfly bites.

Topical formulations have also been developed for sandfly control. Molina et al. (Veterinary Parasitology, 2012, 187, 529-533) have in particular demonstrated that the ExSpot® product (65% permethrin in propylene glycol monomethyl ether) makes it possible to protect dogs against P. perniciosus bites for 22 days after administration. Molina et al. (The Veterinary Record, Aug. 12, 2006) have also shown that a composition in spray form comprising permethrin and pyriproxyfen makes it possible to obtain a repellent effect against P. perniciosus for at least 21 days. Frenais et al. (Parasites & Vectors, 2014, 7:217) have shown that the Activyl® Tick Plus product (indoxacarb and permethrin) at the minimum recommended dose makes it possible to obtain an excellent repellent efficacy against P. perniciosus for between 2 and 14 days and also a significant efficacy for at least 29 days. Miro et al. (Veterinary Parasitology, 2007, 143, 375-379) have shown a repellent effect against P. perniciosus for 21 days, in dogs, of a “spot-on” formulation comprising the 10% (weight/volume) imidacloprid/50% (weight/volume) permethrin combination. Finally, Dumont et al. (Parasites & Vectors, 2015, 8:49) have for their part demonstrated that a combination of fipronil with permethrin exhibits a significant repellent effect against P. perniciosus as soon as it is applied in dogs, this being for 4 weeks.

As briefly illustrated above, no treatment developed to date using topical formulations makes it possible to obtain a repellent and/or insecticidal efficacy against P. perniciosus for a period of more than 4 weeks.

Thus, there remains today, in the context of sandfly control and/or leishmaniosis control, a need to develop new formulations which have a repellent and/or insecticidal effect against sandflies with prolonged efficacy.

### SUMMARY OF THE INVENTION

In this context, the inventors have surprisingly demonstrated that a veterinary composition comprising a compound of the neonicotinoid family and a compound of the pyrethroid family makes it possible to obtain prolonged sandfly control compared with the already existing treatments. In particular, the inventors have demonstrated that such a composition allows effective sandfly control beyond 4 weeks and in particular for at least 5 weeks, illustrated in particular by a greater residual repellent efficacy against P. perniciosus of at least 89% after 37 days and at least 74% after 44 days.

The present invention therefore relates to the use of a veterinary composition comprising a compound of the neonicotinoid family and a compound of the pyrethroid family for sandfly control in non-human mammals, said composition being intended to be administered in a single dose, at least every five weeks.

In one particular embodiment according to the invention, the weight ratio of the compound of the pyrethroid family to the compound of the neonicotinoid family is between 4 and 15, preferentially between 6 and 9, and even more preferentially between 7 and 8.

Preferably, the compound of the neonicotinoid family is dinotefuran.

Preferably, the compound of the pyrethroid family is permethrin.

In another particular embodiment according to the invention, the composition also comprises an insect growth regulator.

In one preferred embodiment, the weight ratio of the insect growth regulator to the compound of the neonicotinoid family is between 0.05 and 0.12, preferentially between 0.06 and 0.1, and even more preferentially between 0.07 and 0.09.

In another preferred embodiment, the insect growth regulator is methoprene or pyriproxyfen, preferably pyriproxyfen.

In one particular embodiment of the invention, the composition is intended to be applied topically to the skin of the non-human mammal.

In one preferred embodiment, the composition is intended to be applied to the skin of the non-human mammal against the direction of the coat.

In one even more preferred embodiment, the composition is intended to be applied continuously against the direction of the coat from the base of the tail, along the dorsal spine up to the shoulder blades of the non-human mammal.

Typically, the non-human mammal is a dog or a cat, preferentially a dog. Particularly, the sandflies are sandflies of the Phlebotomus, Sergentomyias or Lutzomyia genus, preferentially of the Phlebotomus genus.

Another subject of the present invention is a veterinary composition as described in the present application, for use thereof in leishmaniosis control in non-human mammals, preferentially cats and/or dogs, even more preferentially dogs.

An additional subject of the invention relates to a kit comprising one or more compartments, said compartments comprising a combination of a compound of the neonicotinoid family, a compound of the pyrethroid family, and optionally an insect growth regulator, for simultaneous use of said composition at least every five weeks, for sandfly control and/or leishmaniosis control in non-human mammals, preferably dogs.

In one particular embodiment, the kit also comprises an instruction sheet or notice regarding the method of administration and the procedure for the combination for sandfly control and/or leishmaniosis control in non-human mammals, preferably dogs.

### DETAILED DESCRIPTION OF THE INVENTION

### Composition

The veterinary compositions of the invention comprise a compound of the neonicotinoid family and a compound of the pyrethroid family, for sandfly control in non-human mammals.

The compounds of the neonicotinoid family are chemically similar to nicotine. They correspond to a class of insecticides that act on the central nervous system of insects by inhibiting nicotinic acetylcholine receptors, thus causing paralysis and death of the parasitic insect. They were introduced onto the market in the 1990s and are particularly active against ectoparasites such as fleas, flies and lice. Compounds of the neonicotinoid family include, without limitation, imidacloprid, thiamethoxam, clothianidine, acetamiprid, thiacloprid, dinotefuran, nitenpyram, imidaclothiz, huanyanglin, guadipyr, paichongding, cycloxaprid and derivatives thereof or pharmaceutically acceptable salts thereof.

A preferred compound of the neonicotinoid family of the invention is dinotefuran.

For the purpose of the present invention, the term “dinotefuran” also comprises the derivatives or analogs thereof, the metabolites thereof and the pharmaceutically acceptable salts thereof.

Dinotefuran was described by the company Mitsui Toatsu Chemicals, Inc. in patent EP 0 649 845 and was developed for insect-pest control. Dinotefuran, the chemical name of which is 2-methyl-1-nitro-3-[(tetrahydro-3-furanyl)methyl]guanidine, corresponds to the following formula:

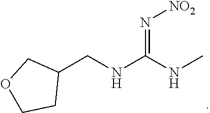

Neonicotinoids and in particular dinotefuran metabolize in the body of non-human mammals and thus prolong their duration of action. The main metabolic pathways of dinotefuran involve N-demethylation, nitroreduction, N-methylene hydroxylation and amine cleavage reactions. The dinotefuran metabolites comprise the compounds described by Simon-Delso et al. (Systemic insecticides (neonicotinoids and fipronil): trends, uses, mode of action and metabolites, Environ. Sci. Pollut. Res., 2015, 22:5-34) and by Ford K A and Casida J E (Unique and common metabolites of thiamethoxam, clothianidin, and dinotefuran in mice, Chem. Res. Toxicol., 2006, 19:1549-1556; Neonicotinoid metabolism: compounds, substituents, pathways, enzymes, organisms, and relevance, J. Agric. Food Chem., 2011, 59:2923-2931) and FAO dinotefuran (http://www.fao.org/fileadmin/templates/agphome/documents/PestsPesticides/JMPR/Evaluation12/Dinotefuran.pdf). In particular, the dinotefuran metabolites include, without limitation, N-desmethyl dinotefuran (2-nitro-1-(tetrahydro-3-furylmethyl)guanidine), DIN-NNO, DIN-dm-NNO, DIN-NNH₂, 1-methyl-3-(tetrahydro-3-furylmethyl)guanidine, 3-(tetrahydro-3-furylmethyl)guanidine, 1-methyl-3-(tetrahydro-3-furylmethyl)urea, 3-(tetrahydro-3-furylmethyl)urea, 2-hydroxy-dinotefuran, 4-hydroxydinotefuran, 1,3-diazinane aminocarbinol, DIN-b (derivative of DIN-dm), DIN-e (guanidine derivative of DIN-a), DIN-f (guanidine derivative of DIN-b), DIN-g (derivative of DIN-5-OH), DIN-h (desmethyl-g), DIN-I (nitroso derivative of DIN-g), DIN-j (nitroso derivative of DIN-h), DIN-k (guanidine derivative of DIN-h), tetrahydrofuran carboxaldehyde (3-furfural), tetrahydrofuran alcohol (3-furfuryl alcohol), 3-tetrahydrofurancarboxylic acid, 4-hydroxy-3-tetrahydrofuranzcarboxylic acid, tetrahydrofuran-3-ylmethylamine, 1-[4-hydroxy-2-(hydroxymethyl)butyl]-3-methyl-2-nitroguanidine, and 3-hydroxydinotefuran.

Typically, the dinotefuran derivatives or analogs comprise all the compounds described in patent EP 0 649 845. More particularly, the dinotefuran derivatives or analogs comprise, without limitation, 1-[{(tetrahydro-3-furanyl)methyl}amino]-1-methylamino-2-nitroethylene, 1-[{(tetrahydro-3-furanyl)methyl}amino]-1-ethylamino-2-nitroethylene, 1-[{(tetrahydro-3-furanyl)methyl}amino]-1-dimethylamino-2-nitroethylene, 1-[{(tetrahydro-3-furanyl)methyl}amino]-1-(1-pyrrolidinyl)-2-nitroethylene, 1-[N-{(tetrahydro-3-furanyl)methyl}-N-methylamino]-1-methylamino-2-nitroethylene, 1-[N-{(tetrahydro-3-furanyl)methyl}-N-propylamino]-1-methylamino-2-nitroethylene, 1-[N-{(tetrahydro-3-furanyl)methyl}-N-propylamino]-1-ethylamino-2-nitroethylene, 1-{(tetrahydro-3-furanyl)methyl}-2-nitro-3-methylguanidine, N-{(tetrahydro-3-furanyl)methyl}-N-(methyl)nitroguanidine, 1-{(tetrahydro-3-furanyl)methyl}-1-ethyl-2-nitro-3-methylguanidine, N-(tetrahydro-3-furanyl)methyl-N∝-cyano(methylthio)formamidine, N-cyano-N-{(tetrahydro-3-furanyl)methyl}acetamidine, N-cyano-N′-{(tetrahydro-3-furanyl)methyl}-N-methylacetamidine, N-[4-{(2-methyl)tetrahydrofuranyl}methyl]-N′-methyl-N″-nitroguanidine, 1-{(tetrahydro-3-furanyl)methyl}-1,2-dicyclohexylcarbonyl-2-methyl-3-nitroguanidine, 1-{(tetrahydro-3-furanyl)methyl}-1,2-diethylcarbonyl-2-methyl-3-nitroguanidine, 1-{(tetrahydro-3-furanyl)methyl}-1,2-dimethoxycarbonyl-2-methyl-3-nitroguanidine, and 1-{(tetrahydro-3-furanyl)methyl}-1,2-dibenzoyl-2-methyl-3-nitroguanidine.

The compounds of the pyrethroid family are compounds which act on the insect nervous system and disrupt neuron function by interacting with sodium channels. Compounds of the pyrethroid family include, without limitation, ethofenprox, permethrin, prallethrin, resmethrin, sumithrin, allethrin, alpha-cypermethrin, bifenthrin, beta-cypermethrin, cyfluthrin, cypermethrin, deltamethrin, flumethrin, esfenvalerate, lamda-cyhalothrin, zeta-cypermethrin, and the derivatives thereof or the pharmaceutically acceptable salts thereof.

A preferred compound of the pyrethroid family is permethrin.

In one particular embodiment, the compositions of the invention also comprise an insect growth regulator

Insect growth regulators are chemical substances which inhibit the lifecycle of insects. Among the insect growth regulators, mention may be made, without limitation, of azadirachtin, hydroprene, methoprene, pyriproxyfen, triflumuron, and the derivatives thereof or the pharmaceutically acceptable salts thereof.

A preferred insect growth regulator compound is pyriproxyfen or methoprene, and more preferentially pyriproxyfen.

The term “pharmaceutically acceptable salts” is intended to mean both organic salts and inorganic salts. Representative examples of inorganic salts comprise hydrochlorides, hydrobromides, iodates, sulfonates and phosphates. Representative examples of organic salts comprise formates, acetates, trichloroacetates, propionates, benzoates, cinnamates, fumarates, maleates and methanesulfonates.

In one particular embodiment, the composition comprises a compound of the neonicotinoid family, preferably dinotefuran, a compound of the pyrethroid family, preferably permethrin, in weight amounts such that the weight ratio of the compound of the pyrethroid family to the compound of the neonicotinoid family is between 4 and 15, preferentially between 6 and 9, and even more preferentially between 7 and 8.

In another particular embodiment, the composition comprises a compound of the neonicotinoid family, preferably dinotefuran, and a compound of the pyrethroid family, preferably permethrin, and an insect growth regulator, preferably pyriproxyfen, in weight amounts such that the weight ratio of the insect growth regulator to the compound of the neonicotinoid family is between 0.05 and 0.12, preferentially between 0.06 and 0.1, and even more preferentially between 0.07 and 0.09.

In one preferred embodiment of the invention, the composition comprises approximately 60% to 95% of permethrin, approximately 6% to 22% of dinotefuran, and optionally approximately 0.8% to 4% of pyriproxyfen. In a more preferred embodiment of the invention, the composition comprises approximately 70% to 90% of permethrin, approximately 8% to 15% of dinotefuran, and optionally approximately 0.9% to 1.5% of pyriproxyfen. According to these preferred embodiments of the invention, the percentages are expressed by weight relative to the total weight of the compounds which are permethrin, dinotefuran and optionally pyriproxyfen.

In another preferred embodiment of the invention, the composition comprises:
approximately 20% to 50%, preferentially approximately 30% to 40%, and even more preferentially approximately 34% to 38%, by weight of permethrin,
approximately 1% to 20%, preferentially approximately 1% to 10%, and even more preferentially approximately 3% to 7%, by weight of dinotefuran, and optionally approximately 0.1% to 2%, preferentially approximately 0.1% to 1%, and even more preferentially 0.2% to 0.6% by weight of pyriproxyfen, relative to the total weight of the composition.

The term “approximately” will be understood by those skilled in the art and can vary to a certain extent according to the context in which it is used. If some uses of this term are not clear for those skilled in the art depending on the context, “approximately” means plus or minus 20%, preferably plus or minus 10% of the specific term.

### Application

The term “non-human mammal” is intended to mean any non-human mammal capable of being bitten or stung by sandflies and of thus developing leishmaniosis or of being a reservoir for this disease, that is to say already suffering from leishmaniosis and able to contaminate another non-human mammal via sandflies. The non-human mammal may in particular be a member of the canine family, such as a dog, a fox, a coyote or a wolf, or a member of the feline family, such as a cat, a lion or a panther. In one preferred embodiment, the non-human mammal belongs to the pets group and is preferentially a dog or a cat, and even more preferentially a dog.

The terms “control” and “controlling” are intended to mean, without limitation, the action of reducing, repelling (anti-engorgement), eradicating, eliminating, killing and preventing sandflies in non-human mammals. The notion of “preventing” also comprises decreasing, reducing or preventing a sandfly blood meal in non-human mammals, which results in reducing the risks of infection of surrounding subjects and thus contributes to limiting the spread of leishmaniosis.

The invention also relates to a method for controlling sandflies in non-human mammals, comprising the administration of an effective amount in a single dose, at least every five weeks, of a composition comprising a compound of the neonicotinoid family, a compound of the pyrethroid family, and optionally an insect growth regulator, in non-human mammals.

In the context of the present invention, the expression “effective amount” means the amount of the compound of the neonicotinoid family, of the compound of the pyrethroid family, and optionally of the insect growth regulator that is capable of causing sufficient sandfly control. It is accepted by those skilled in the art and in particular by the European Medicines Agency (EMA) that sufficient control is obtained when at least 80% of sandflies are controlled.

The sandfly repellent effect is evaluated using the Abbott formula (Abbott, W. S.: A method of computing the effectiveness of an insecticide; J. Econ. Entomol.; 1925; 18; 265-267) calculating the percentage (%) corresponding to the difference between the number of engorged sandflies calculated in a non-treated non-human mammal (control group) and the number of engorged sandflies calculated in a treated non-human mammal (treated group) relative to the number of engorged sandflies calculated in a non-treated, non-human mammal, that is to say:

((Number of engorged sandflies of the control group−Number of engorged sandflies of the treated group)/Number of engorged sandflies of the control group)×100.

An engorged sandfly (or sandfly fed with blood) corresponds to a sandfly that has already stung or bitten the non-human mammal. The arithmetic means are used.

The sandfly insecticidal effect is evaluated by calculating the percentage (%) corresponding to the difference between the number of sandflies observed in a non-treated, non-human mammal (control group) and the number of sandflies observed in a treated, non-human mammal (treated group) relative to the number of sandflies observed in a non-treated, non-human mammal, that is to say:

((Number of sandflies of the control group−Number of sandflies of the treated group)/Number of sandflies of the control group)×100. The arithmetic means are used.

A subject of the invention also relates to a method for controlling at least approximately 80% of sandflies in non-human mammals, comprising the administration of an effective amount in a single dose, at least every five weeks, of a composition comprising a compound of the neonicotinoid family, a compound of the pyrethroid family, and optionally an insect growth regulator, in said non-human mammals.

As briefly described in the introduction, sandflies are acknowledged to be leishmaniosis vectors. Sandflies can in particular be of the Phlebotomus, Sergentomyias or Lutzomyia genus.

Among the species belonging to the sandfly genus, mention may be made of Phlebotomus ariasi, Phlebotomus balanicus, Phlebotomus intermedius, Phlebotomus longicuspis, Phlebotomus papatasi, Phlebotomus perniciosus, and Phlebotomus sergentif. On the American continents, sandflies belong to the Lutzomyia genus. Mention may be made in particular of Lutzomyia longipalpis. In one preferred embodiment of the invention, the sandflies are of the Phlebotomus genus and are typically Phlebotomus perniciosus.

The invention therefore also relates to a veterinary composition comprising a compound of the neonicotinoid family, a compound of the pyrethroid family, and optionally an insect growth regulator, for use thereof in leishmaniosis control in non-human mammals, said composition being intended to be administered in a single dose, at least every five weeks.

The invention also relates to the use of a veterinary composition comprising a compound of the neonicotinoid family, a compound of the pyrethroid family, and optionally an insect growth regulator, in the production of a medicament for leishmaniosis control in non-human mammals, said composition being intended to be administered in a single dose, at least every five weeks.

The invention also relates to a method for leishmaniosis control in non-human mammals, comprising the administration of an effective amount of a composition comprising a compound of the neonicotinoid family, a compound of the pyrethroid family and optionally an insect growth regulator, in non-human mammals which may or may not be suffering from leishmaniosis, said composition being intended to be administered in a single dose, at least every five weeks.

In the context of the invention, the expressions “leishmaniosis control”, “leishmaniosis treatment” and “leishmaniosis prevention” denote the protection of the non-human mammal against leishmaniosis, that is to say the protection of the non-human mammal by sandfly control. According to one particular embodiment, these expressions include the preventive treatment of the non-human mammal against leishmaniosis.

According to a first aspect, a preventive treatment denotes a treatment carried out before the non-human mammal has been exposed to or has been in contact with the causative agent of leishmaniosis, in the case in point sandflies. A preventive treatment therefore reduces the risks of the non-human mammal developing leishmaniosis.

According to a second aspect, a preventive treatment also denotes a treatment carried out in a non-human mammal suffering from leishmaniosis. The treatment carried out in a sick subject makes it possible to control the sandflies in its environment and to reduce the risks of infection in the surrounding healthy subjects, thus contributing to limiting the spread of leishmaniosis.

According to one preferred embodiment of the invention, the composition is intended to be administered in a single dose, at least every five weeks. According to this embodiment, the composition is administered to the non-human mammal at a time T0 and is then again administered at a time T1, at least 5 weeks later. In particular, the treatment can be repeated every 5 weeks, or preferably for 10 weeks, 15 weeks, 20 weeks, 25 weeks, 50 weeks, 2 years, 5 years, and even more preferentially until the death of the non-human mammal.

According to another particular embodiment, the compositions as defined above are intended to be applied topically to the skin of the non-human mammal. Typically, the compositions used in the present invention can be in the form of solutions, emulsions or gels. The compositions of “spot-on” or “line-on” type are particularly suitable for a topical application.

In one preferred embodiment of a topical application, the compositions are applied to the skin of the non-human mammal, against the direction of the coat. The expression “an application against the direction of the coat” is intended to mean an application to the skin of the non-human mammal, in the direction opposite to the implantation of the hairs. For the non-human mammals to which the invention relates, the application against the direction of the coat is generally carried out in the direction starting from the base of the tail toward the shoulder blades of the non-human mammal.

Advantageously, the veterinary compositions used in the invention are applied against the direction of the coat and continuously. The continuous application of the composition is carried out by keeping the composition in contact with the animals' skin, this being until all of the desired dose of the composition is administered externally to the skin of the non-human mammal. The notion “continuously” can also be defined as an infinite succession of spots.

The continuous application of the composition can be carried out along a rectilinear path. In one preferred embodiment, the compositions used are applied continuously against the direction of the coat, starting from the base of the tail, along the dorsal spine up to the level of the shoulder blades of the non-human mammal. In particular, the user holds the animal against himself with one of his hands and applies the composition continuously against the direction of the coat using his other hand starting from the base of the tail, along the dorsal spine up to the level of the shoulder blades of the non-human mammal.

The compositions used in the invention are preferentially formulated in unit dose form adjusted to the weight and/or to the size of the non-human mammal, all of the dose being applied to the non-human mammal. Typically, the doses of composition range from 0.1 to 100 ml, preferentially from 0.5 to 20 ml, and even more preferentially from 0.5 to 10 ml. When the non-human mammals to which the invention relates are dogs and cats, the doses of composition typically range from 0.5 to 10 ml. According to certain particular embodiments, the compositions are applied at a dose of between 0.05 and 0.6 ml/kg of body weight of the non-human mammal.

According to another aspect of the invention, the compound of the neonicotinoid family, the compound of the pyrethroid family and optionally the insect growth regulator, as defined previously and including the preferred embodiments, are in compositions distinct from one another.

Another subject of the invention therefore relates to the use of a combination intended to be administered in a single dose, at least every five weeks, and comprising a compound of the neonicotinoid family, a compound of the pyrethroid family, and optionally an insect growth regulator, for sandfly control in non-human mammals. An additional subject of the invention relates to such a combination for use thereof in leishmaniosis control in non-human mammals.

Thus, the present invention also provides a kit comprising one or more compartments, said compartments comprising a combination of a compound of the neonicotinoid family, a compound of the pyrethroid family, and optionally an insect growth regulator, for simultaneous use of said composition at least every five weeks, for sandfly control and/or for leishmaniosis control in non-human mammals, preferably dogs.

The expression “simultaneous use” means that the compounds forming the combination as defined above are administered at the same time in non-human mammals.

According to one specific embodiment, the kit also comprises an instruction sheet or notice and the procedure for the combination for sandfly control and/or for leishmaniosis control in non-human mammals, preferably dogs.

A product for implementing the use of the compositions of the invention for sandfly control and/or for leishmaniosis control in non-human mammals can in particular be the product comprising the dinotefuran-permethrin-pyriproxyfen combination such as that sold under the name Vectra®3D by Ceva Sante Animale.

Other aspects and advantages of the invention will emerge on reading the examples which follow, which should be considered to be illustrative and nonlimiting.

### EXAMPLES

### Example 1

### Materials and Methods

Sixteen dogs of the “Beagle” breed were divided up into two homogeneous groups according to their capacity to be stung by sandflies (day −7). The first group (n=8, 12.5±1.4 kg average body weight) corresponds to the control group. 3.6 ml of Vectra®3D (composition of the invention comprising 4.95% by weight of dinotefuran, 36.08% by weight of permethrin and 0.44% by weight of pyriproxyfen, relative to the total weight of the composition) are administered to the second group (n=8, 11.6±0.7 kg average body weight) on day 0. Each dog is then exposed for 1 hour, in the dark, to 85±10 non-engorged adult females and 10-20 males of Phlebotomus perniciosus on D-7, D2, D9, D16, D23, D30, D37, D44. The sandflies used had not eaten. The sandflies were collected one hour after each exposure. All the dead or alive sandflies were frozen and the females were classified as being engorged or non-engorged by means of a visual examination using a stereomicroscope. The repellent effect was calculated using the Abbott formula and by considering all the engorged females to be a failure. The insecticidal effect was calculated using the Abbott formula and by considering all the live females to be a failure. The repellent and insecticidal effects of Vectra®3D were evaluated on D2, D9, D16, D23, D30, D37 and D44 by analysis of variance and using non-parametric tests (Kriuskal-Wallis).

### Results

The results of the study are presented below in table 1 and are compared with various products sold in sandfly control.

TABLE 1

| | | D + 2 | D + 9 | D + 16 | D + 23 | D + 30 | D + 37 | D + 44 |
|---|---|---|---|---|---|---|---|---|
| Product | | W0 | W1 | W2 | W3 | W4 | W5 | W6 |
| Vectra ®3D | Repellent | 98 | 97 | 99 | 95 | 92 | 89 | 74 |
| (Dinotefuran-permethrin- | efficacy (%) | | | | | | | |
| pyriproxifen) | Repellent | 47 | 45 | 30 | 24 | 19 | 17 | 8 |
| | efficacy (%) | | | | | | | |
| ¹Exspot ™ | Repellent | 99 | 93 | 87 | 68 | 61 | 57 | 18 |
| (Permethrin) | efficacy (%) | | | | | | | |
| | Repellent | 98 | 80 | 43 | 32 | 24 | 6 | 3 |
| | efficacy (%) | | | | | | | |
| ²Duowin Spray | Repellent | — | 99 | 81 | 71 | 47 | 45 | 38 |
| (permethrin-pyriproxifen) | efficacy (%) | | | | | | | |
| | Repellent | — | 30 | 32 | 7 | 1 | 3 | 1 |
| | efficacy (%) | | | | | | | |
| ³Activyl ® Tick Plus | Repellent | 99 | 98 | 96 | 88 | 84 | 60 | 38 |
| (indoxacarb - permethrin) | efficacy (%) | | | | | | | |
| | Repellent | 32 | 27 | 9 | 0 | 4 | 1 | — |
| | efficacy (%) | | | | | | | |
| ⁴Advantix ® | Repellent | 98 | 96 | 96 | 93 | 74 | 57 | 42 |
| (imidacloprid - permethrin) | efficacy (%) | | | | | | | |
| | Repellent | 53 | 49 | 15 | 13 | 3 | 2 | — |
| | efficacy (%) | | | | | | | |
| ⁵Frontline TriAct ® | Repellent | 99 | 99 | 99 | 93 | 81 | 53 | 47 |
| (fipronil - permethrin) | efficacy (%) | | | | | | | |
| | Repellent | 98 | 99 | 98 | 99 | 66 | 27 | — |
| | efficacy (%) | | | | | | | |

¹Molina et al., Veterinary Parasitology, 2012, 187, 529-533.
²Molina et al., Veterinary Record, 2006, 159, 206-209.
³Fresnais et al., Parasites & Vectors, 2014, 7: 217.
⁴Miro et al., Veterinary Parasitology, 2007, 143, 375-379.
⁵Dumont et al., Parasites & Vectors, 2015, 8: 49.
D = Day
W = Week

The results show that the composition of the invention comprising dinotefuran and permethrin exhibits a repellent efficacy against sandflies of greater than 80% after five weeks, whereas the prior art products do not make it possible to obtain an acceptable protection (that is to say a repellent efficacy of greater than 80%) only for a maximum period of 4 weeks.

The inventors therefore demonstrated, surprisingly, that the compositions of the invention made it possible to control sandflies in non-human mammals with a prolonged efficacy, greater than or equal to 5 weeks, compared with the already existing treatments.

### Example 2

Effect of a product comprising dinotefuran, permethrin and pyriproxyfen against L. longipalpis in experimentally infested dogs.

Leishmania (Kinetoplastida, trypanosomatidae) are protozoan parasites of great medical and veterinary importance, which are transmitted to a host by the sandfly of the Phlebotomus genus on the European continent and the Lutzomyia genus on the American continent.

This study was designed to determine the insecticidal efficacy (repellent capacity) of the Vectra® 3D product (dinotefuran, permethrin and pyriproxyfen) against L. longipalpis in the experimentally infected dogs. Twelve adult dogs were assigned to a treated group and a control group based on the amount of feed during the pre-treatment and the sex. The dogs of the treated group were treated with Vectra® 3D locally on day 0. All the animals were exposed under sedation and for 1 hour to adult sandflies that had not eaten (5-200 males and females), on days D+1, D+7, D+14, D+21, D+28, D+35 and D+42.

After the exposure to the sandflies, the dogs were removed from the exposure chamber and the sandflies were collected, classified as live or dead, and stored.

The live sandflies were incubated for 24 hours after the exposure in order to evaluate the survival rate. All insects were classified as male or female and filled with blood or non-fed. Insecticidal efficacy (repellent capacity) was calculated using the Abbott formula and the mean number of females filled with blood in the treated and untreated groups. The number of sandflies fed was compared by a Student's test, using statistical software, SigmaPlot12.

The mean number of females that were alive and filled with blood observed throughout the experimental period was 51.96, which result demonstrates the success of the methodology on sandfly exposure. During the statistical analysis, a significant difference (p<0.05) was shown for the tests when the treated group is compared with the control group (table 2).

TABLE 2
Table 2. Mean number of females alive and filled with blood on
the dogs subjected to the present study on days:
D + 1, D + 7, D + 14, D + 21, D + 28, D + 35 and D + 42.

| | | | | Statistical |
|---|---|---|---|---|
| | | | | relevance |
| | Mean | | | (significant = |
| Days | Treated | Control | p Value | sig.) |
| D + 1 | 0.83 | 45.66 | 0.002 | Sig. |
| D + 7 | 0.33 | 47.33 | 0.002 | Sig. |
| D + 14 | 3.16 | 57.33 | 0.002 | Sig. |
| D + 21 | 5.66 | 54.83 | 0.002 | Sig. |
| D + 28 | 14.33 | 54.66 | <0.001 | Sig. |
| D + 35 | 12.85 | 56.27 | 0.002 | Sig. |
| D + 42 | 29.06 | 55.75 | 0.005 | Sig. |

The difference between the groups was significant at all the timepoints (p<0.05). The mean efficacy (87.45%) during the entire experimental period was sufficient (>80%). These results demonstrate that Vectra® 3D provides an effective insecticidal/repellent effect against L. longipalpis for 5 weeks (D+35), or even beyond (D+42).

1. A method for controlling sandflies in a non-human mammal, comprising administering an effective amount of a veterinary composition comprising a compound of the neonicotinoid family and a compound of the pyrethroid family, in a single dose, at least every five weeks.

2. The method according to claim 1, wherein the weight ratio of the compound of the pyrethroid family to the compound of the neonicotinoid family is between 4 and 15.

3. The method according to claim 1, wherein the compound of the neonicotinoid family is dinotefuran.

4. The method according to claim 1, wherein the compound of the pyrethroid family is permethrin.

5. The method according to claim 1, wherein the composition also comprises an insect growth regulator.

6. The method according to claim 5, wherein the weight ratio of the insect growth regulator to the compound of the neonicotinoid family is between 0.05 and 0.12.

7. The method according to claim 5, wherein the insect growth regulator is methoprene or pyriproxyfen.

8. The method according to claim 1, wherein the composition is applied topically to the skin of the non-human mammal.

9. The method according to claim 1, wherein the composition is applied to the skin of the non-human mammal, against the direction of the coat.

10. The method according to claim 1, wherein the composition is applied continuously against the direction of the coat starting from the base of the tail, along the dorsal spine up to the level of the shoulder blades of the non-human mammal.

11. The method according to claim 1, wherein the non-human mammal is a dog or a cat.

12. The method according to claim 1, wherein the sandflies are of the Phlebotomus, Sergentomyias or Lutzomyia genus.

13. A method for controlling leishmaniosis in a non-human mammal, comprising administering an effective amount of the veterinary composition as defined in claim 1.

14. A kit comprising one or more compartments, said compartments comprising a combination of a compound of the neonicotinoid family, a compound of the pyrethroid family, and optionally an insect growth regulator, for simultaneous use of said combination at least every five weeks, for sandfly control and/or leishmaniosis control in a non-human mammal.

15. The kit according to claim 14, also comprising an instruction sheet or notice regarding the method of administration and the procedure for the combination for sandfly control and/or leishmaniosis control in a non-human mammal.

16. The method according to claim 1, wherein the weight ratio of the compound of the pyrethroid family to the compound of the neonicotinoid family is between 6 and 9.

17. The method according to claim 1, wherein the weight ratio of the compound of the pyrethroid family to the compound of the neonicotinoid family is between 7 and 8.

18. The method according to claim 1, wherein the composition also comprises an insect growth regulator, and wherein the weight ratio of the insect growth regulator to the compound of the neonicotinoid family is between 0.06 and 0.1.

19. The method according to claim 1, wherein the composition also comprises an insect growth regulator, and wherein the weight ratio of the insect growth regulator to the compound of the neonicotinoid family is between 0.07 and 0.09.

20. The method according to claim 13, wherein the non-human mammal is a dog or a cat.
